(19) United States
(12) Patent Application Publication
(10) Pub. No.: US 2015/0278859 A1
(43) Pub. Date: Oct. 1, 2015

(54) RECURRING COMMERCE

(71) Applicant: Neel Sundaresan, Mountain View, CA (US)

(72) Inventor: Neel Sundaresan, Mountain View, CA (US)

(21) Appl. No.: 14/230,600

(22) Filed: Mar. 31, 2014

(51) Int. Cl. G06Q 30/02

(52) U.S. Cl. CPC G06Q 30/0255

(57) ABSTRACT

A system and method for supporting recurring online buying is disclosed. Users may automatically make a purchase subscription product item a subscription product. Incentives and reminders may be offered by to encourage subscription purchasing. The system may perform collaborative filtering to gain knowledge regarding subscription product items. Interactive subscription suggestions may be prompted by the aggregate buying histories of and individual or many users. A method and system for Recurring Commerce comprises collecting, by a seller, historic recurring purchasing data, compiling the collected historic recurring buying data for collaborative filtering, collaboratively filtering the compiled recurring buying data to identify subscription product items repeatedly purchased by one or more users, receiving, from a user, placement of an identified subscription product item in an online shopping user interface, and making, by the seller, a targeted data driven subscription offer for the identified subscription product item to the user.

### TECHNICAL FIELD

The present application relates generally to the technical field of commercial uses of search algorithms implemented on a computer and, in one example embodiment, to methods and systems to enable navigation of data subscription product items based on recurring commerce.

### BACKGROUND

A user searching an information resource (e.g., database) may encounter challenges. One such challenge may be that a search mechanism (e.g., a search engine) that is utilized to search the information resource may return search results that are inconvenient to the user. For example, the search mechanism may respond to a query from users having repetitive buying patterns with search results that are unrelated to previous purchases. Users buy some products on a regular basis. Users may purchase paper towels and diapers on a weekly basis, and cleaning products on a monthly basis, for example. Currently, online user interfaces neither capture user repetitive intent, nor provide convenience or incentives to users making repeat, i.e. recurring, purchases. First time buyers shopping for subscription product items common to repeat buying are not offered convenience features or incentives to purchase the same subscription product items again. Thus, there is a need for convenience features and incentives for subscription purchasing of retail subscription product items online.

### BRIEF DESCRIPTION OF THE DRAWINGS

Some embodiments are illustrated by way of example and not limitation in the figures of the accompanying drawings in which:

FIG. 1 is a block diagram depicting a system suitable for Recurring Commerce, according to some example embodiments;

FIG. 2 is a block diagram illustrating a network-based publication system 200 for processing a search query, presenting search results (e.g., marketplace listings), and offering subscription services and benefits as described more fully herein.

FIG. 3 Shows a block diagram of a high level overview flow chart of Recurring Commerce, according to some example embodiments;

FIG. 4 is a block diagram illustrating components of a machine, according to some example embodiments, able to read instructions from a machine-readable medium and perform any one or more of the methodologies for Recurring Commerce discussed herein.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Example methods and systems for Recurring Commerce are described. In the following description, for purposes of explanation, numerous specific details are set forth in order to provide a thorough understanding of example embodiments. It will be evident, however, to one skilled in the art that the present invention may be practiced without these specific details.

Today, search engines that search information resources to display commercial products only process orders as separate transactions. A system and method for a user interface that supports recurring buying is disclosed. Users repeatedly buying same subscription product items, and first time users buying commonly recurring purchased subscription product items, may automatically make a purchase a subscription product. Incentives and reminders may be offered by the system to encourage subscription purchasing where a past history is known. When there is no past history, the system may ask whether the user desires to establish a subscription product item as a subscription product. Alternatively, the system may perform collaborative filtering to gain knowledge regarding subscription product items particularly suited to subscription purchasing for interactively suggesting subscriptions for frequently bought subscription product items to users. In other words, interactive subscription suggestions may be prompted by the aggregate buying histories of many users. The system may also offer discounts based on subscription length and other bulk shipping discounts that may apply. Offline, the system may mark subscription products and purchases for inventory, whole sale buying projections and pre-shipping to warehouses.

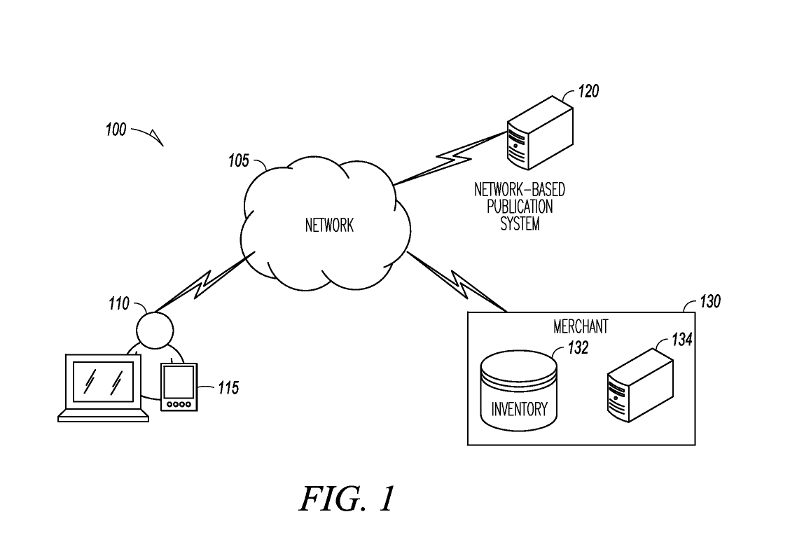

FIG. 1 is a network diagram illustrating a network environment suitable for Recurring Commerce, according to some example embodiments. FIG. 1 shows a block diagram depicting a system 100 for identifying subscription subscription product items and offering subscription services and benefits to users. The system 100 can include a user 110, a network-based publication system 120 with a search engine, and one or more merchants 130 (and merchant systems). In an example, the user 110 can connect to the network-based publication system 120 via a client computing device 115 (e.g., desktop, laptop, smart phone, Personal Digital Assistant (PDA), or similar electronic device capable of some form of data connectivity) and network 105. The network-based publication system 120 will receive and process a query from the user's client computing device 115, and return search results in a search results page or similar User interface (UI), typically with the most relevant results listed first (or, at the top) and may offer subscriptions and subscription benefits related to displayed search results.

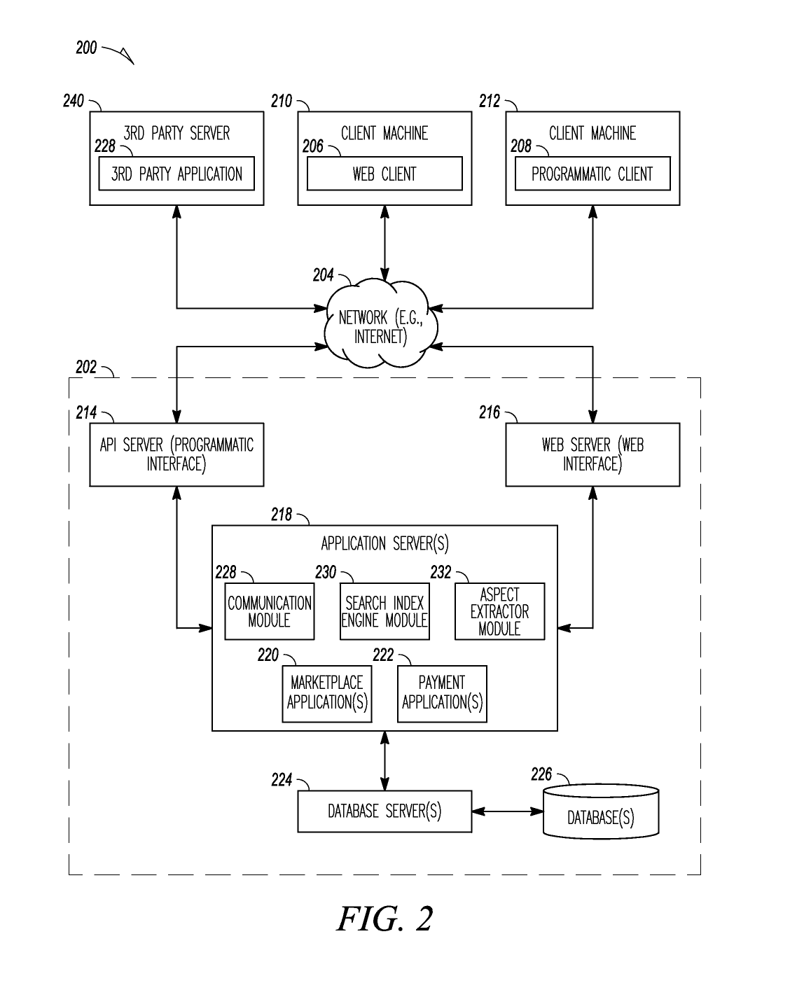

In an example embodiment, the merchant 130 can operate computer systems, such as an inventory system 132 or a Point of Sale (POS) system 134. The network-based publication system 120 can interact with any of the systems used by merchant 130 for operation of the merchant's retail or service business. In an example, the network-based publication system 120 can work with both POS system 134 and inventory system 132 to obtain access to inventory available at individual retail locations operated by the merchant. This inventory information can be used in both generating product or service listings, and selecting and ordering search results served by the network-based publication system 120. An example network-based publication system 120 is detailed below in FIG. 2.

FIG. 2 is a block diagram illustrating a network-based publication system 200 for processing a search query, presenting search results (e.g., marketplace listings), and offering subscription services and benefits as described more fully herein. The block diagram depicts a network-based publication system 200 (in the exemplary form of a client-server system), within which an example embodiment of Recurring Commerce can be deployed. A networked system 200 is shown, in the example form of a network-based location-aware publication, advertisement, or marketplace system, that provides server-side functionality, via a network 204 (e.g., the Internet or WAN) to one or more client machines 210, 212. FIG. 2 illustrates, for example, a web client 206 (e.g., a browser, such as the Internet Explorer browser developed by Microsoft Corporation of Redmond, Wash. State) and a programmatic client 208 executing on respective client machines 210 and 212. In an example, the client machines 210 and 212 can be in the form of a mobile device, such as client computing device 115.

An Application Programming Interface (API) server 214 and a web server 216 are coupled to, and provide programmatic and web interfaces respectively to, one or more application servers 218. The application servers 218 host one or more marketplace application modules 220 (in certain examples, these can also include commerce modules, advertising modules, and marketplace modules, to name a few), payment application(s) 222, aspect extractor module 232 for generating dynamic offers, search engine index module 230, and communication module 228. The application server(s) 218 are, in turn, shown to be coupled to one or more database server(s) 224 that facilitate access to one or more databases 226. In some examples, the application server 218 can access the databases 226 directly (not shown) without the need for a database server 224.

The publication modules 220 may provide a number of publication and search functions and services to users that access the networked system 200. The payment application(s) 222 may likewise provide a number of payment services and functions to users. The payment application(s) 222 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various publication modules 220, within retail locations, or within external online retail venues. The payment application(s) 222 may also be configured to present or facilitate a redemption of offers, generated by the dynamic offer modules 222, to a user during checkout (or prior to checkout, while the user is still actively shopping). The offer modules 222 may provide dynamic context sensitive offers (e.g., coupons or immediate discount deals on targeted products or services) to users of the networked system 200. The offer modules 222 can be configured to use all of the various communication mechanisms provided by the networked system 200 to present offer options to users. The offer options can be personalized based on current location, time of day, user profile data, past purchase history, or recent physical or online behaviors recorded by the network-based system 200, among other things (e.g., context information). While the publication modules 220, payment application(s) 222, and offer modules 222 are shown in FIG. 2 to all form part of the networked system 200, it will be appreciated that, in alternative embodiments, the payment application(s) 222 may form part of a payment service that is separate and distinct from the networked system 200. Additionally, in some examples, the offer modules 222 may be part of the payment service or may form an offer generation service separate and distinct from the networked system 200.

Further, while the system 200 shown in FIG. 2 employs a client-server architecture, the embodiments of the present invention are of course not limited to such an architecture, and could equally well find application in a distributed, or peer-to-peer, architecture system, for example. The various publication modules 220, payment application(s) 222, and offer modules 222 could also be implemented as standalone systems or software programs, which do not necessarily have networking capabilities.

The web client 206 accesses the various publication modules 220, payment application(s) 222, and offer modules 222 via the web interface supported by the web server 216. Similarly, the programmatic client 208 accesses the various services and functions provided by the publication modules 220, payment application(s) 222, and offer modules 222 via the programmatic interface provided by the API server 214. The programmatic client 208 may, for example, be a smartphone application that enables users to communicate search queries to the system 200 while leveraging user profile data and current location information provided by the smartphone or accessed over the network 200. FIG. 2 also illustrates a third-party application 228, executing on a third-party server machine 240, as having programmatic access to the networked system 200 via the programmatic interface provided by the API server 214. For example, the third-party application 228 may, utilizing information retrieved from the networked system 202, support one or more features or functions on a website hosted by the third party. The third-party website may, for example, provide one or more promotional, marketplace or payment functions that are supported by the relevant applications of the networked system 200. Additionally, the third-party website may provide merchants with access to the offer modules 222 for configuration purposes. In certain examples, merchants can use programmatic interfaces provided by the API server 214 to develop and implement rules-based pricing schemes that can be implemented via the publication modules 220, payment application(s) 222, and offer modules 222.

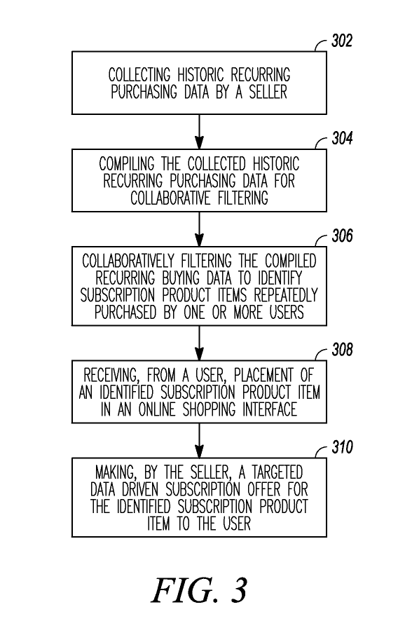

FIG. 3 shows a block diagram of a high level overview flow chart of Recurring Commerce, according to some example embodiments. Operations in the method 300 may be performed by the networked system 202 using the marketplace application(s) 220 module of the application server 218 in conjunction with a data base(s) 226 and database server(s) 226 described above with respect to FIGS. 1 and 2. As shown in FIG. 3, the method 300 includes operations 302-310.

Many products, which may be identified by collaborative filtering are bought repeatedly by users of online purchasing interfaces. Nondurable goods or soft goods (consumables) are often repeatedly purchased at regular intervals. For example, a mother may regularly order a month supply of disposable diapers. A user may order regular supplies of subscription product items such as cleaning supplies, pet food, or other household goods depending on the amount of household space available for storage of supplies. Oftentimes, users would prefer to, but cannot, enjoy the benefits of buying in bulk from large discount sellers due to lack of space for storing large lots of subscription product items. By offering the user a subscription on subscription product items that are typically repeatedly purchased by the individual user or a demographic of like users, the user may benefit from discounts and other incentives to purchases at regular intervals as well as convenience and confidence in managing budgets and time. Automatic shipments at known prices may prevent buyers from repeating the purchase from another seller by encouraging the user with sale prices, bonus points, convenience, adjustable delivery intervals, or other incentives.

Beginning in operation 302 of Recurring Commerce methodology, a seller collects recurring buying data. Recurring buying data may be collected for an individual user, a user demographic, product demographic, or any other combination of recurring buying factors. Control flows to operation 304.

In operation 304, the collected recurring buying data is compiled for collaborative filtering of recurring buying factors. Control flows to operation 306.

In operation 306, the complied recurring buying data is analyzed to identify subscription product items purchased repeatedly. The data may be analyzed for any technically advantageous factors related to recurring purchases by individual or groups of buyers, or individual product subscription product items or groups of product subscription product items. The data may be collaboratively filtered to identify subscription product items.

Collaborative filtering comprises a technique used by some recommender systems. In general, collaborative filtering is the process of filtering for information or patterns using techniques involving collaboration among multiple agents, viewpoints, data sources, etc. Applications of collaborative filtering typically involve very large data sets. Collaborative filtering methods have been applied to many different kinds of data including: sensing and monitoring data, such as in mineral exploration, environmental sensing over large areas or multiple sensors; financial data, such as financial service institutions that integrate many financial sources; or in electronic commerce and web applications where the focus is on user data, etc.

Collaborative filtering for user data is a method of making automatic predictions (filtering) about the interests of a user by collecting preferences or taste information from many users (collaborating). The underlying assumption of the collaborative filtering approach is that if a person A has the same opinion as a person B on an issue, A is more likely to have B's opinion on a different issue x than to have the opinion on x of a person chosen randomly. For example, a collaborative filtering recommendation system for television tastes could make predictions about which television show a user should like given a partial list of that user's tastes (likes or dislikes).Note that these predictions are specific to the user, but use information gleaned from many users. This differs from the simpler approach of giving an average (non-specific) score for each subscription product item of interest, for example based on its number of votes.

In operation 306, the complied recurring buying data is collaboratively filtered to identify subscription product items repeatedly purchased by one or more users. Control flows to operation 308.

In operation 308, a seller receives from a user, placement of a subscription product item identified as likely to be or has previously been repeatedly purchased, into an online shopping cart or other online merchant interface. Control flow proceeds to operation 310.

In operation 310, the seller makes a targeted data driven subscription offer for the identified subscription product item based on the analytical results of operation 306. Acceptance of the subscription offer may comprise any modality of user interface selection. In one embodiment, a pop up box or window for selecting a subscription offer maybe presented in the shopping cart or a sidebar at the time of purchase. In other embodiments, a subscription offer on a subscription product item may be made after checkout. After checkout offers may be made by email or other modality. A user may specify delivery intervals or accept a suggested subscription interval. The suggested subscription delivery interval may be based on the collaborative filtering results of operation 306. A subscription offer may be triggered by multiple purchases of the same subscription product item by a user or the collaboratively filtered results of operation 306. An after checkout subscription offer may be trigger by the passage of an amount of time since a subscription product item purchase, determined from the buying pattern of the user and/or other users. Incentives of sale pricing or other benefits may be included in the subscription offer.

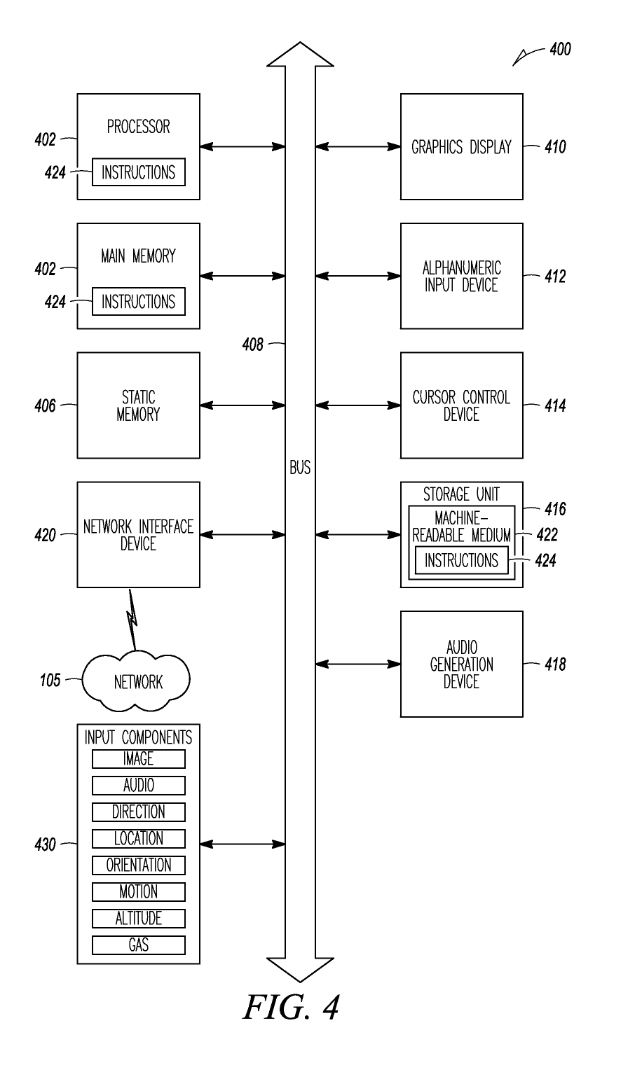

FIG. 4 is a block diagram illustrating components of a machine 400, according to some example embodiments, able to read instructions 424 from a machine-readable medium 422 (e.g., a machine-readable storage medium, a computer-readable storage medium, or any suitable combination thereof) and perform any one or more of the methodologies discussed herein, in whole or in part. Specifically, FIG. 4 shows the machine 400 in the example form of computer system within which the instructions 424 (e.g., software, a program, an application, an applet, an app, or other executable code) for causing the machine 400 to perform any one or more of the Recurring Commerce methodologies discussed herein may be executed, in whole or in part. In alternative embodiments, the machine 400 operates as a standalone device or may be connected (e.g., networked) to other machines. In a networked deployment, the machine 400 may operate in the capacity of a server machine or a client machine in a server-client network environment, or as a peer machine in a distributed (e.g., peer-to-peer) network environment.

The machine 400 may be a server computer, a client computer, a personal computer (PC), a tablet computer, a laptop computer, a netbook, a cellular telephone, a smartphone, a STB, a personal digital assistant (PDA), a web appliance, a network router, a network switch, a network bridge, or any machine capable of executing the instructions 424, sequentially or otherwise, that specify actions to be taken by that machine. Further, while only a single machine is illustrated, the term “machine” shall also be taken to include any collection of machines that individually or jointly execute the instructions 424 to perform all or part of any one or more of the methodologies discussed herein.

The machine 400 includes a processor 402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 404, and a static memory 406, which are configured to communicate with each other via a bus 408. The processor 402 may contain microcircuits that are configurable, temporarily or permanently, by some or all of the instructions 424 such that the processor 402 is configurable to perform any one or more of the methodologies described herein, in whole or in part. For example, a set of one or more microcircuits of the processor 402 may be configurable to execute one or more modules (e.g., software modules) described herein.

The machine 400 may further include a graphics, or video, display 410 (e.g., a plasma display panel (PDP), a light emitting diode (LED) display, a liquid crystal display (LCD), a projector, a cathode ray tube (CRT), or any other display capable of displaying graphics or video). The machine 400 may also include an alphanumeric input device 412 (e.g., a keyboard or keypad), a cursor control device 414 (e.g., a mouse, a touchpad, a trackball, a joystick, a motion sensor, an eye tracking device, or other pointing instrument), a storage, or drive, unit 416, an audio signal generation device 418 (e.g., a sound card, an amplifier, a speaker, a headphone jack, or any suitable combination thereof), and a network interface device 420.

The storage unit 416 includes the machine-readable medium 422 (e.g., a tangible and non-transitory machine-readable storage medium) on which are stored the instructions 424 embodying any one or more of the methodologies or functions described herein. The instructions 424 may also reside, completely or at least partially, within the main memory 404, within the processor 402 (e.g., within the processor's cache memory), or both, before or during execution thereof by the machine 400. Accordingly, the main memory 404 and the processor 402 may be considered machine-readable media (e.g., tangible and non-transitory machine-readable media). The instructions 424 may be transmitted or received over the network 490 via the network interface device 420. For example, the network interface device 420 may communicate the instructions 424 using any one or more transfer protocols (e.g., hypertext transfer protocol (HTTP)).

In some example embodiments, the machine 400 may be a fixed or portable computing device, such as a desktop computer, laptop computer, smart phone or tablet computer, and have one or more additional input components 430 (e.g., sensors or gauges). Examples of such input components 430 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 422 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 424 for execution by the machine 400, such that the instructions 424, when executed by one or more processors of the machine 400 (e.g., processor 402), cause the machine 400 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to send, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

In one embodiment, a method comprises collecting, by a seller, historic recurring purchasing data, compiling the collected historic recurring purchasing data for collaborative filtering, collaboratively filtering the compiled recurring purchasing data to identify subscription product items repeatedly purchased by one or more users, receiving, from a user, placement of an identified subscription product item in an online shopping user interface, and making, by the seller, a targeted data driven subscription offer for the identified subscription product item to the user.

In another embodiment, a non-transitory machine-readable storage medium comprising instructions that, when executed by one or more processors of a machine, cause the machine to perform operations comprising collecting, by a seller, historic recurring purchasing data, compiling the collected historic recurring purchasing data for collaborative filtering, collaboratively filtering the compiled recurring purchasing data to identify subscription product items repeatedly purchased by one or more users, receiving, from a user, placement of an identified subscription product item in an online shopping user interface, and making, by the seller, a targeted data driven subscription offer for the identified subscription product item to the user.

In another embodiment, a system for enabling navigation of a plurality of data subscription product items corresponding to a query comprises a communication module for receiving a user query, a search index engine for collecting user search queries, and an aspect extractor module for collecting, by a seller, historic recurring purchasing data, compiling the collected historic recurring purchasing data for collaborative filtering, collaboratively filtering the compiled recurring purchasing data to identify subscription product items repeatedly purchased by one or more users, receiving, from a user, placement of an identified subscription product item in an online shopping user interface, and making, by the seller, a targeted data driven subscription offer for the identified subscription product item to the user.

In another embodiment, the subscription offer comprises incentives to accept the subscription offer.

In another embodiment, the subscription offer is made after checkout.

In another embodiment, the subscription offer comprises delivery of the identified subscription product item at intervals determined by the user.

In another embodiment, an online shopping interface comprises a shopping cart or basket.

In another embodiment, the subscription offer is made at the time of sale.

In another embodiment, a suggested subscription delivery interval is based on collaboratively filtering the historic recurring purchasing data.

Thus, a method and system for Recurring Commerce have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of enabling a sale of a data item corresponding to a query, the method comprising:
collecting, by a seller, historic recurring purchasing data;
compiling the collected historic recurring purchasing data for collaborative filtering;
collaboratively filtering the compiled recurring buying data to identify subscription product items repeatedly purchased by one or more users;
receiving, from a user, placement of an identified subscription product item in an online shopping user interface; and
making, by the seller, a targeted data driven subscription offer for the identified subscription product item to the user.

2. The method of claim 1, wherein the subscription offer comprises incentives to accept the subscription offer.

3. The method of claim 1, wherein the subscription offer comprises delivery of the identified subscription product item at intervals determined by the user.

4. The method of claim 1, wherein the subscription offer is made at the time of sale.

5. The method of claim 1, wherein the subscription offer is made after checkout.

6. The method of claim 1, wherein the offer comprises a suggested subscription delivery interval based on collaboratively filtering the historic recurring purchasing data.

7. The method of claim 1, wherein the online shopping interface comprises a shopping cart or basket.

8. A non-transitory machine-readable storage medium comprising instructions that, when executed by one or more processors of a machine, cause the machine to perform operations comprising:
collecting, by a seller, historic recurring purchasing data;
compiling the collected historic recurring purchasing data for collaborative filtering;
collaboratively filtering the compiled recurring buying data to identify subscription product items repeatedly purchased by one or more users;
receiving, from a user, placement of an identified subscription product item in an online shopping user interface; and
making, by the seller, a targeted data driven subscription offer for the identified subscription product item to the user.

9. The non-transitory machine-readable storage medium of claim 8, wherein the subscription offer comprises incentives to accept the subscription offer.

10. The non-transitory machine-readable storage medium of claim 8, wherein the subscription offer comprises delivery of the identified subscription product item at intervals determined by the user.

11. The non-transitory machine-readable storage medium of claim 8, wherein the subscription offer is made at the time of sale.

12. The non-transitory machine-readable storage medium of claim 8, wherein the subscription offer is made after checkout.

13. The non-transitory machine-readable storage medium of claim 8, wherein the offer comprises a suggested subscription delivery interval based on collaboratively filtering the historic recurring purchasing data.

14. The non-transitory machine-readable storage medium of claim 8, wherein the online shopping interface comprises a shopping cart or basket.

15. A system for enabling navigation of a plurality of data subscription product items corresponding to a query comprising:
a communication module for receiving a user query;
a search index engine for collecting user search queries; and
an aspect extractor module for collecting, by a seller, historic recurring purchasing data, compiling the collected historic recurring purchasing data for collaborative filtering, collaboratively filtering the compiled recurring purchasing data to identify subscription product items repeatedly purchased by one or more users, receiving, from a user, placement of an identified subscription product item in an online shopping user interface, and making, by the seller, a targeted data driven subscription offer for the identified subscription product item to the user.

16. The system of claim 15, wherein the subscription offer comprises incentives to accept the subscription offer.

17. The system of claim 15, wherein the subscription offer comprises delivery of the identified subscription product item at intervals determined by the user.

18. The system of claim 15, wherein the subscription offer is made at the time of sale.

19. The system of claim 15, wherein the subscription offer is made after checkout.

20. The system of claim 15, wherein the offer comprises a suggested subscription delivery interval based on collaboratively filtering the historic recurring purchasing data.
